(19) United States
(12) Patent Application Publication
(10) Pub. No.: US 2010/0053516 A1
(43) Pub. Date: Mar. 4, 2010

(54) COLOR PIXEL, COLOR DISPLAY APPARATUS AND DISPLAYING METHOD

(75) Inventors: Ming-Hung LU, Kaohsiung City (TW); Sheng-Han TSAI, Kaohsiung City (TW); Chien-Hung CHEN, Kaohsiung City (TW)

Correspondence Address: LOWE HAUPTMAN HAM & BERNER, LLP, 1700 DIAGONAL ROAD, SUITE 300, ALEXANDRIA, VA, 22314, US

(73) Assignee: INNOVISION FLEXTECH CORPORATION, Kaohsiung City (TW)

(21) Appl. No.: 12/330,115

(22) Filed: Dec. 8, 2008

(30) Foreign Application Priority Data
Aug. 27, 2008 (TW) 097132646

(51) Int. Cl. G02F 1/1335

(52) U.S. Cl. 349/113

(57) ABSTRACT

A transflective layer is inserted in between a light modulator and a specific-color reflector to allow partial transmission and partial reflection of the light transmitted through the light modulator. The specific-color reflector is arranged to reflect a light component of a designated color of the transmitted light.

### RELATED APPLICATIONS

The present application is based on, and claims priority from, Taiwan Application Serial Number 097132646, filed Aug. 27, 2008, the disclosure of which is hereby incorporated by reference herein in its entirety.

### BACKGROUND

This disclosure relates to a color pixel, a color display apparatus and a displaying method.

FIG. 1 shows a schematic side view of a known black and white pixel, as seen from top to bottom. The pixel includes: a combination of a top plate 20, a transparent electrode 21, a light modulator 30, a transparent pixel electrode 11, a bottom plate 10, and an ambient light reflector 12.

When the light modulator 30 turns on, most of the ambient light “A” passes through the light modulator 30 and reaches the ambient light reflector 12. Reflective light “B” from ambient light reflector 12 reaches the top of the system, i.e., a bright state can be observed by an observer on top of the display. On the other hand, when the light modulator 30 turns off, most of the ambient light “A” is prevented from passing through the light modulator 30 and no reflective light “B” can reach the top of the display, i.e., a dark state will be observed by an observer on top of the display. When the ambient light is natural white or colorless, the bright state appears white and the dark state appears black, and therefore the known configuration is called “black-white” pixel or display apparatus. Nowadays, a black-white pixel/display apparatus is no longer satisfactory to users; a color pixel/display apparatus is desired.

### BRIEF DESCRIPTION OF THE DRAWINGS

One or more embodiments are illustrated by way of example, and not by limitation, in the figures of the accompanying drawings, wherein elements having the same reference numeral designations represent like elements throughout.

FIG. 1 is a schematic side view of a known black and white pixel.

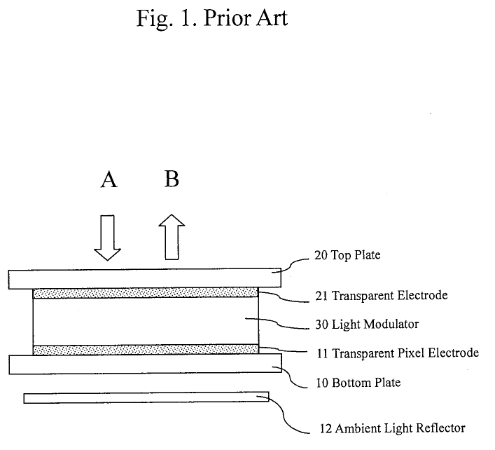

FIG. 2. is a schematic view showing a principle of an embodiment of the present invention

FIG. 3. is a schematic side view of an embodiment of the present invention.

FIG. 4. is a schematic side view of another embodiment of the present invention.

FIG. 5. is a schematic side view of still another embodiment of the present invention.

FIG. 6. is a schematic side view of still another embodiment of the present invention.

FIG. 7. is a schematic side view of still another embodiment of the present invention.

### DETAILED DESCRIPTION OF EMBODIMENTS

An embodiment of the present invention provides a mechanism for “a color pixel” to provide a color display apparatus that changes its color softly with a transflective layer inserted in between a modulator and a reflector. The color display apparatus is composed of one or more color pixels arranged, e.g., in an array.

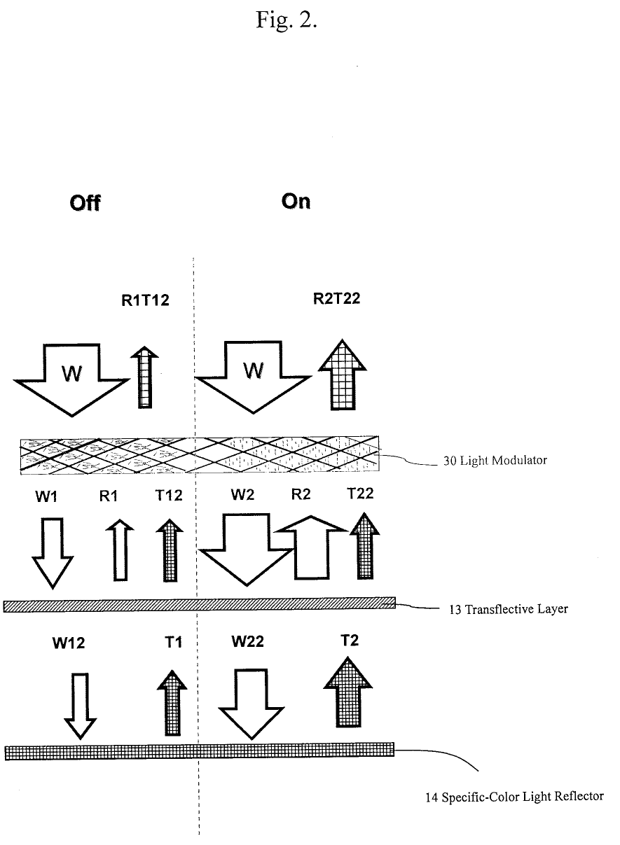

The right side of FIG. 2 shows a state when a light modulator 30 turns on and the left side of FIG. 2 shows a state when the light modulator 30 turns off. From top to bottom, the color pixel comprises: the light modulator 30, a transflective layer 13, and a specific-color light reflector 14. An observer on top of the display should be able to see a minimum amount of light brightness when the light modulator 30 turns off as shown on the left side of FIG. 2. On the other hand, the observer should be able to see a maximum amount of light brightness when the light modulator 30 turns on as shown on the right side of FIG. 2.

Either Polymer-dispersed liquid crystal (PDLC) or Polymer-network liquid crystal (PNLC) can be used in an embodiment for the light modulator 30. Either PDLC or PNLC scatters, rather than blocking, light while the liquid crystal molecules are random, and allows light to pass through while the liquid crystal molecules are aligned. In the latter case, the ambient light passes through the modulator 30 due to the aligned liquid crystal molecules. Other types of liquid crystal having properties similar to PDLC or PNLC, such as twisted-nematic liquid-crystal, can be used for the light modulator 30. The light modulator 30 can be turned on/off through appropriately controlling a voltage across a top electrode and a bottom electrode (not shown).

On the right side of FIG. 2, where the state when the light modulator 30 turns on is shown, most of the ambient light “W” should be able to pass through the light modulator 30. W2, a portion of W, passes through the light modulator 30 and reaches the transflective layer 13. W22, a portion of W2, further passes through the transflective layer 13 and reaches the specific-color light reflector 14. T2, a portion of the light W22, is reflected from the specific-color light reflector 14. T22, a portion of the light T2, passes through the transflective layer 13 and reaches the light modulator 30. R2, a portion of light W2, is reflected by the transflective layer 13 towards the light modulator 30. Finally, a portion of R2 plus a portion of T22 pass through the light modulator 30 and reach the observer on top of the system, as indicated by the hatched arrow R2T22.

On the left side of FIG. 2, where the state when the light modulator 30 turns off is shown, most of the ambient light “W” should be scattered within the light modulator 30. Due to the scattering effect, only W1, a small portion of W, passes through the light modulator 30 and reaches the transflective layer 13. W12, a portion of W1, further passes through the transflective layer 13 and reaches the specific-color light reflector 14. T1, a portion of the light W12, is reflected from the specific-color light reflector 14. T12, a portion of the light T1, passes through the transflective layer 13 and reaches the light modulator 30. R1, a portion of light W1, is reflected by the transflective layer 13 towards the light modulator 30. Finally, a portion of R1 plus a portion of T12 pass through the light modulator 30 and reach the observer on top of the system, as indicated by the hatched arrow R1T12. The light amount of R1T12 is relatively small compared to the light amount of R2T22. Therefore, the pixel in the state “Off” on the left appears darker than in the state “On” on the right.

The color displayed in the color pixel is determined by the color reflected by the corresponding reflector 14. The color selected by the specific-color light reflector 14 can be any visible color depending on design choices. A product (e.g., a color display apparatus) can then be configured to be capable of displaying multiple colors by combining a plurality of color pixels where the color reflected from the specific-color light reflector 14 of one color pixel is different from the color reflected from the specific-color light reflector 14 of another color pixel.

The color selected to be reflected by the specific-color light reflector 14 include, but are not limited to the following: red, orange, yellow green, blue, cyanine, purple, and black. For example, the color pixel displays red if the corresponding specific-color light reflector 14 is made such that red light is reflected, wherein only the red component of the incident light is reflected and the remaining components of the incident light are absorbed by the reflector 14. For another example, the color pixel displays green if the corresponding specific-color light reflector 14 is made such that green light is reflected, wherein only the green component of the incident light is reflected and the remaining components of the incident light are absorbed by the reflector 14 etc.

The transflective layer 13 is inserted between the light modulator 30 and the specific-color light reflector 14 to allow a part of the incident light to pass and reflect a part of the incident light. Such arrangement diminishes the sharpness of color change so as to provide the color pixel with a capability to change its color softly between the on and off states.

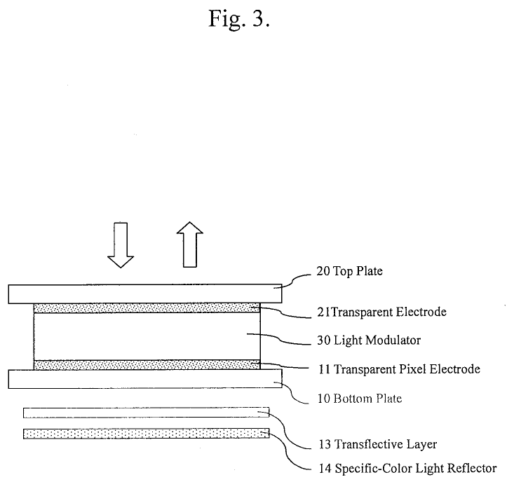

FIG. 3 shows a configuration of a color pixel in accordance with an embodiment. The color pixel includes, from top to bottom, a top plate 20, a transparent electrode 21, the light modulator 30, a transparent pixel electrode 11, a bottom plate 10, the transflective layer 13 and the specific-color light reflector 14. The transparent electrode 21 is provided on the top of the light modulator 30. The transparent pixel electrode 11 is provided on the bottom of the light modulator 30. The transparent electrode 21, the light modulator 30 and the transparent pixel electrode 11 are provided between the top plate 20 and the bottom plate 10. The transflective layer 13 is provided between the bottom plate 10 and the specific-color light reflector 14. The principle of the color pixel in FIG. 3 is essentially the same as that described with respect to FIG. 2. The transparent electrode 21 and the transparent pixel electrode 11 are used to control the light modulator 30. The top plate 20 and the bottom plate 10 are used as a support and a protection layer to the elements provided between the top plate 20 and the bottom plate 10.

The disclosed color pixel is applicable to various color display apparatuses such as electronic digital watches, electronic digital thermometers, electronic digital timepieces, color back panels etc. One or more color pixels are used as the display components in the color display apparatus.

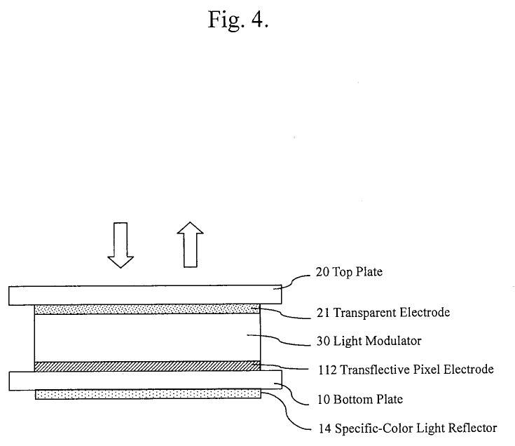

FIG. 4 shows a configuration of a color pixel in accordance with another embodiment of the present invention. The color pixel includes, from top to bottom, a top plate 20, a transparent electrode 21, a light modulator 30, a transflective pixel electrode 112, a bottom plate 10 and a specific-color light reflector 14. The transflective pixel electrode 112 is arranged on the bottom of the light modulator 30. The transflective pixel electrode 112 plays a dual role of both a transflective layer and a pixel electrode. Compared with FIG. 3, the configuration of FIG. 4 has omitted an independent transflective layer. The transflective pixel electrode 112 can be made of a thin film metal. The principle of the color pixel of FIG. 4 is essentially the same as that described with respect to FIG. 2.

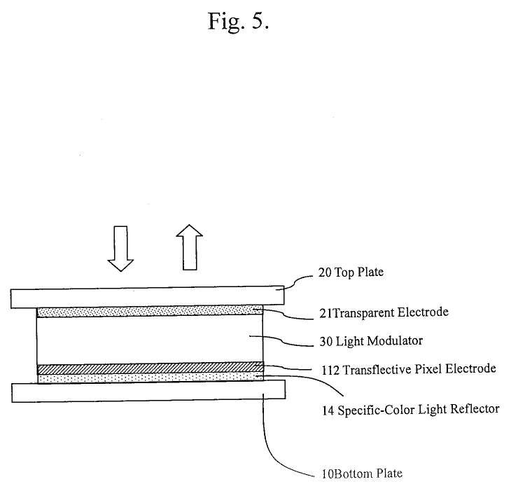

FIG. 5 shows a configuration of a color pixel in accordance with still another embodiment of the present invention. The color pixel includes, from top to bottom, a top plate 20, a transparent electrode 21, a light modulator 30, a transflective pixel electrode 112, a specific-color light reflector 14 and a bottom plate 10. The specific-color light reflector 14 is provided between the transflective pixel electrode 112 and the bottom plate 10. The principle of the color pixel of FIG. 5 is essentially the same as that described with respect to FIG. 2.

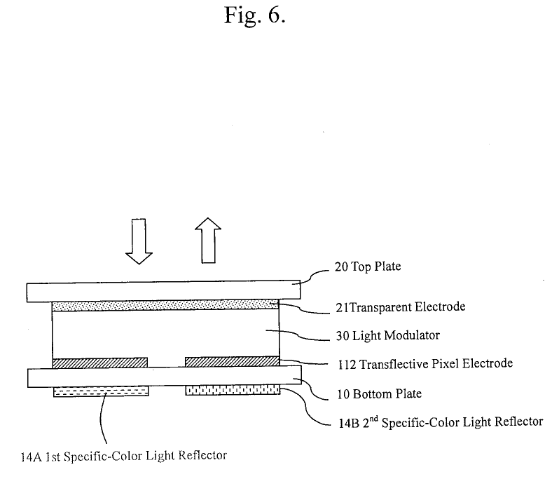

FIG. 6 shows a configuration of a color pixel in accordance with still another embodiment of the present invention. The color pixel includes, from top to bottom, a top plate 20, a transparent electrode 21, a light modulator 30, coplanar two transflective pixel electrodes 112, a bottom plate 10, and coplanar two specific-color light reflectors 14A, 14B. The two transflective pixel electrodes 112 are arranged separately from each other. Each of the two reflectors 14A, 14B is configured to be in a position downward aligned to one of the two transflective pixel electrodes 112. The color reflected by the first specific-color light reflector 14A is different from the color reflected by the second specific-color light reflector 14B so as to provide a multicolor pixel. The principle of the color pixel of FIG. 6 is essentially the same as that described with respect to FIG. 2.

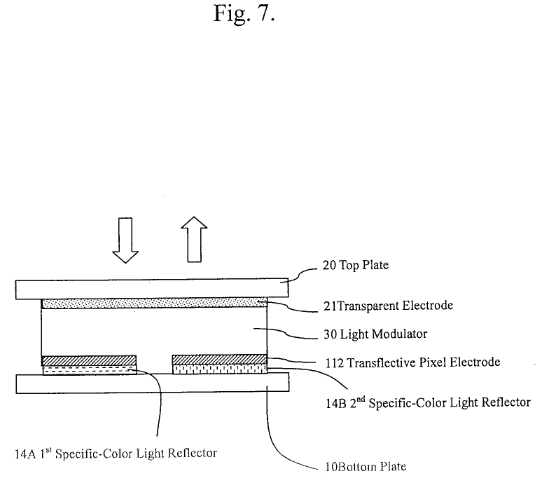

FIG. 7 shows a configuration of a color pixel in accordance with still another embodiment of the present invention. The color pixel includes, from top to bottom, a top plate 20, a transparent electrode 21, a light modulator 30, coplanar two transflective pixel electrodes 112, coplanar two specific-color light reflector 14A, 14B and a bottom plate 10. The two transflective pixel electrodes 112 are arranged separately from each other. Each of the two specific-color light reflectors 14A, 14B is configured to be immediately below one of the two transflective pixel electrodes 112. The principle of the color pixel of FIG. 7 is essentially the same as that described with respect to FIG. 2.

While several embodiments have been described by way of example, it will be apparent to those skilled in the art that various modifications may be made without departing from the spirit of the present invention. Such modifications are all within the scope of the present invention, as defined by the appended claims.

What is claimed is:

1. A color pixel, comprising:
a light modulator for controllably transmitting an amount of ambient light;
a transflective layer positioned under said modulator for transmitting a first light portion of the light transmitted through the light modulator and reflecting a second light portion of said light; and
a specific-color reflector positioned under said transflective layer for reflecting a component of a predetermined color of the first light portion back to the transflective layer and the light modulator.

2. A color pixel as claimed in claim 1, further comprising:
a transparent electrode on top of said light modulator;
a transparent pixel electrode on bottom of said light modulator; and
a bottom plate under said transparent pixel electrode;
wherein said transflective layer is positioned between said bottom plate and said specific-color light reflector.

3. A color pixel as claimed in claim 1, wherein
said transflective layer is a transflective pixel electrode.
said color pixel further comprises a bottom plate positioned under said transflective pixel electrode; and
said specific-color reflector is positioned under said bottom plate.

4. A color pixel as claimed in claim 1, wherein
said transflective layer is a transflective pixel electrode; and
said color pixel further comprises a bottom plate under said specific-color reflector.

5. A color pixel as claimed in claim 1, wherein:
said transflective layer comprises two coplanar transflective pixel electrodes; and
said specific-color light reflector comprises two coplanar specific-color reflectors each aligned to one of said two transflective pixel electrodes.

6. A color pixel as claimed in claim 5, further comprising:
a bottom plate under said coplanar transflective pixel electrodes;
wherein said coplanar specific-color reflectors are positioned under said bottom plate.

7. A color pixel as claimed in claim 5, further comprising:
a bottom plate under said coplanar specific-color reflectors.

8. A color pixel as claimed in claim 5, wherein:
said coplanar specific-color reflectors are configured for reflecting light of different colors.

9. A color pixel as claimed in claim 1, wherein:
the specific-color reflector is configured for absorbing light components of colors other than the predetermined color.

10. A color display apparatus, comprising:
a plurality of color pixels;
wherein each of said color pixels includes;
a light modulator for controllably transmitting an amount of ambient light;
a transflective layer positioned under said modulator for transmitting a first light portion of the light transmitted through the light modulator and reflecting a second light portion of said light; and
a specific-color reflector positioned under said transflective layer for reflecting a component of a predetermined color of the first light portion back to the transflective layer and the light modulator.

11. The color display apparatus of claim 10, wherein:
the predetermined color to be reflected from the specific-color reflector of one of said color pixels is different from the predetermined color to be reflected from the specific-color reflector of another of said color pixels.

12. The color display apparatus of claim 10, wherein
the transflective layer of each of said color pixels is a transflective pixel electrode.

13. The color display apparatus of claim 10, wherein in each of said color pixels
said transflective layer comprises two coplanar transflective pixel electrodes; and
said specific-color light reflector comprises two coplanar specific-color reflectors each aligned to one of said two transflective pixel electrodes.

14. The color display apparatus of claim 13, wherein in each of said color pixels
said coplanar specific-color reflectors are configured for reflecting light of different colors.

15. The color display apparatus of claim 10, wherein in each of said color pixels
the specific-color reflector is configured for absorbing light components of colors other than the predetermined color.
